(19) United States
(12) Patent Application Publication
(10) Pub. No.: US 2026/0303943 A1
(43) Pub. Date: Oct. 1, 2026

(54) HOME ASSISTANT ARTIFICIAL INTELLIGENCE AI TRAINER AND HUB

(71) Applicant: Michael Sabo, Grandville, MI (US)

(72) Inventor: Michael Sabo, Grandville, MI (US)

(21) Appl. No.: 19/096,922

(22) Filed: Apr. 1, 2025

(51) Int. Cl. H04N 23/611; H04N 23/62; H04N 23/667; H04N 23/695

(52) U.S. Cl. CPC H04N 23/611; H04N 23/62; H04N 23/667; H04N 23/695

(57) ABSTRACT

A digital appliance includes a rotational camera configured to rotate 360 degrees in a horizontal plane and rotate 180 degrees in a vertical plane and produce an audio/visual data and a data tag, a facial recognition hardware configured to drive the rotational camera to track in the horizontal plane and the vertical planes, a tracking LED configured to indicate a movement of the rotational camera and an audio/visual recording configured to train an artificial intelligence AI on the data and the data tag from the rotational camera.

### SUMMARY OF THE INVENTION

A digital appliance includes a rotational camera configured to rotate 360 degrees in a horizontal plane and rotate 180 degrees in a vertical plane and produce an audio/visual data and a data tag, a facial recognition hardware configured to drive the rotational camera to track in the horizontal plane and the vertical planes, a tracking LED configured to indicate a movement of the rotational camera and an audio/visual recording configured to train an artificial intelligence AI on the data and the data tag from the rotational camera.

### BRIEF DESCRIPTION OF THE DRAWINGS

FIG. 1 is a first depiction of the Home Assistant Artificial Intelligence AI Trainer and Hub in accordance with an embodiment of the present disclosure.

FIG. 2 is a second depiction of the Home Assistant AI Trainer and Hub in accordance with an embodiment of the present disclosure.

FIG. 3 is a block diagram of the HAAI Trainer and Hub hardware in accordance with an embodiment of the present disclosure.

FIG. 4 is a block diagram of the HAAI Trainer and Hub heuristics in accordance with an embodiment of the present disclosure.

Throughout the description, similar reference numbers may be used to identify similar elements depicted in multiple embodiments. Although specific embodiments of the invention have been described and illustrated, the invention is not to be limited to the specific forms or arrangements of parts so described and illustrated. The scope of the invention is to be defined by the claims appended hereto and their equivalents.

### DETAILED DESCRIPTION

Reference will now be made to exemplary embodiments illustrated in the drawings and specific language will be used herein to describe the same. It will nevertheless be understood that no limitation of the scope of the disclosure is thereby intended. Alterations and further modifications of the inventive features illustrated herein and additional applications of the principles of the inventions as illustrated herein, which would occur to one skilled in the relevant art and having possession of this disclosure, are to be considered within the scope of the invention.

Throughout the disclosure, the terms “app” and “application” are used interchangeably to refer to the hardware and non-volatile storage of data and instructions to transform the disclosure and the claimed limitations.

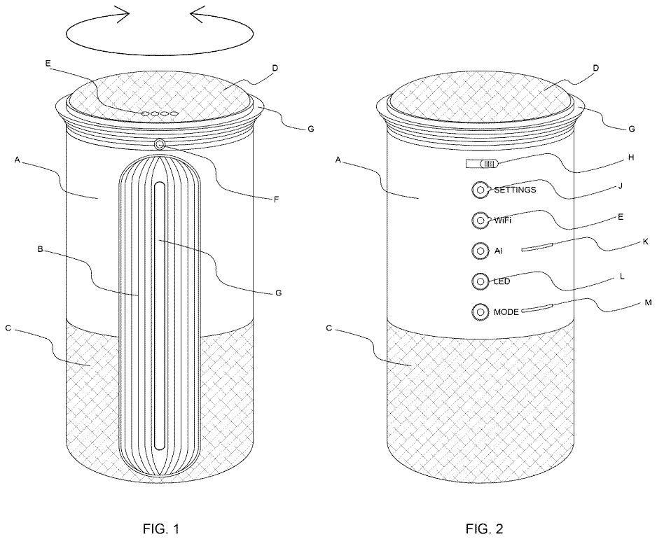

FIG. 1 is a first depiction of the Home Assistant Artificial Intelligence AI Trainer and Hub in accordance with an embodiment of the present disclosure. The depiction includes the ChatGPT bot device A, the Audio LED light effect B, the speaker C, the microphone D, the control buttons E, the rotational camera for video recording and facial recognition that rotates in a 360 degree horizontal plane and a 180 degree vertical plane F, the spinning animated LED light that lights up like a control panel G and a flush manual switch H.

FIG. 2 is a second depiction of the Home Assistant AI Trainer and Hub in accordance with an embodiment of the present disclosure. The depiction includes radial buttons for the ChatGPT bot device A, the Audio LED light effect B, the speaker C, the microphone D, the control buttons E, the rotational camera for video recording and facial recognition that rotates in a 360 degree horizontal plane and a 180 degree vertical plane F, the spinning animated LED light that lights up like a control panel G and a flush manual switch H, settings J, AI engagement and sharing mode K, LED L, and mode selection M.

The primary purpose of the disclosure, also known as the Thinkbox Pro, is to function as a state-of-the-art, all-in-one AI home assistant that significantly enhances everyday living through intelligent and personalized interactions. Traditional smart home devices are often associated with communication barriers whereas many existing systems struggle to accurately interpret a user's requests, often leading to frustration and inefficiency. Beyond this, these modern support tools tend to lack the ability to provide personalized assistance offering generic responses that don't account for individual preferences or needs.

Ingenious and practical, the disclosure introduces a revolutionized home system that serves as a central hub for smart home integration, allowing users to manage various devices from a single interface. Unlike traditional smart home devices that often provide limited functionality and impersonal responses, the disclosure is designed to simplify daily tasks while providing real-time support across a wide range of activities to create a more efficient, enjoyable, and intuitive living environment. Users can expect not just assistance with basic tasks but also a dynamic, engaging experience that transforms how they interact with technology in their homes.

At the heart of the disclosure is the voice and facial recognition camera which tracks a user and records audio/visual data for training an AI with the user's habits, quirks, mannerisms etc. The disclosure employs advanced natural language processing capabilities to enable dynamic, conversational exchanges. This feature allows users to interact in a way that feels more like speaking to a knowledgeable friend rather than a machine and provides future-proof technology as ChatGPT will continue to evolve and impact social norms.

Accompanying the audio/visual AI training is the Audio LED Light Effect, which provides visual indicators for the device's operational status—orange for listening/input awareness, green for recording/actively engaged—to provide immediate, clear feedback about what the device is doing at any moment. Audio quality is crucial in any home assistant, and the high-quality speaker in the disclosure ensures that audio output is crystal clear, whether delivering responses, playing music, or issuing notifications. This attention to sound quality not only improves communication but also enriches the overall user experience.

Complementing the speaker is the advanced microphone, designed with an array-based setup that captures voice commands from multiple angles effectively enhancing usability by improving AI audio/visual training accuracy, even in noisy environments, allowing for true hands-free operation. For users who prefer a tactile experience, the disclosure includes control buttons that provide an alternative method of interaction. These buttons enable quick access to essential functions, accommodating different user preferences and situations where voice commands may not be practical.

Additionally, the device features a 360-degree rotating camera which offers real-time audio/visual AI training and feedback and supports facial recognition allowing users to follow along with guided tasks, whether they're cooking, re-pairing something, or engaging in other activities that benefit from audio/visual AI training and support.

FIG. 3 is a block diagram of the HAAI Trainer and Hub hardware in accordance with an embodiment of the present disclosure. The diagram includes the camera data, the microphone data and the data tag in communication with the system bus. The Graphics processing Unit (GPU), the Central processing unit (CPU) and the memory are also in connection with the system bus. Additionally, the GPU and the CPU are in direct communication with each other.

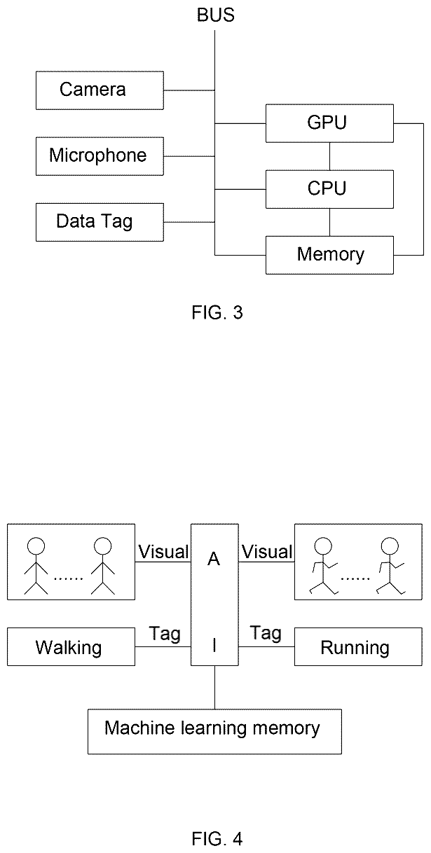

FIG. 4 is a block diagram of the HAAI Trainer and Hub heuristics in accordance with an embodiment of the present disclosure. The diagram includes visual data for walking and running among other activities and observations coming from the HAAI Trainer and Hub which are tagged by a user or by the AI itself in machine learning and stored in the machine learning memory which is part of central memory and discrete memory as required by embodiments and design and product constraints.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

What is claimed is:

1. A digital appliance comprising: a rotational camera configured to rotate 360 degrees in a horizontal plane and rotate 180 degrees in a vertical plane and produce an audio/visual data and a data tag; a facial recognition hardware configured to drive the rotational camera to track in the horizontal plane and the vertical planes; a tracking LED configured to indicate a movement of the rotational camera; and an audio/visual recording configured to train an artificial intelligence AI on the data and the data tag from the rotational camera.

2. The digital appliance of claim 1, further comprising a graphic processing unit (gpu) configured to process the data per the data tag.

3. The digital appliance of claim 2, further comprising a wifi connection for sharing the graphics processing unit processed data per the data tag.

4. The digital appliance of claim 1, further comprising a radial button to engage the AI in a mode for training the AI.

5. The digital appliance of claim 1, further comprising a radial button for engaging the AI in a non-sharing mode.

6. The digital appliance of claim 1, further comprising a rotational microphone configured to track the rotational camera for the audio data and data tag.

7. The digital appliance of claim 1, further comprising a unidirectional microphone configured to pick up the audio data and audio data tag.

8. The digital appliance of claim 1, further comprising a settings radial button configured to enable a selection of settings for the rotational camera.

9. The digital appliance of claim 1, further comprising a cpu computer processing unit configured to stream the data and the data tag to an external receiver.

10. The digital appliance of claim 1, further comprising an internal digital memory for storing the data and the data tag.

11. The digital appliance of claim 1, further comprising a facial recognition training mode configured to supply data and a data tag for training the facial recognition.

12. The digital appliance of claim 1, wherein the data tag includes data for the facial recognition.

13. The digital appliance of claim 1, wherein the data tag includes data derived from a plurality of facial recognition habits.

14. The digital appliance of claim 1, wherein the audio data includes data derived from a plurality of voice recognition habits.

15. The digital appliance of claim 1, wherein the visual data and visual data tag are derived from a plurality of visual tasks.
